(19) United States
(12) Patent Application Publication
(10) Pub. No.: US 2023/0422006 A1
(43) Pub. Date: Dec. 28, 2023

(54) VALIDATION OF A V2X MESSAGE

(71) Applicant: AVL LIST GMBH, Graz (AT)

(72) Inventor: Peter Priller, Gratwein-Straßengel (AT)

(21) Appl. No.: 18/035,787

(22) PCT Filed: Nov. 8, 2021
(86) PCT No.: PCT/AT2021/060417

§ 371 Date: May 8, 2023

(30) Foreign Application Priority Data
Nov. 9, 2020 (AT) A50966/2020

(51) Int. Cl. H04W 4/40; H04W 4/029

(52) U.S. Cl. CPC H04W 4/40; H04W 4/029

(57) ABSTRACT

In order to specify an improved method for validating a V2X message (3) sent by a transmitter (2) and received by a receiver (1) arranged on a vehicle, at least one actual physical received signal property of the V2X message (3) is determined, when the V2X message (3) is received, and a purported transmitter position (p2) of the transmitter (2) is determined from the V2X message (3). Local environment geodata, comprising a positioning a number of stationary objects (O1, O2, O3, O4), are provided, based on the purported transmitter position (p2) and taking into account the environmental geodata and the receiver position (P1), a signal path (x) of the V2X message (3) is simulated and at least one simulated physical received signal property is determined from the simulated signal path (x) and the receiver position (P1). The V2X message (3) is validated, if the at least one simulated physical received signal property differs from the at least one actual physical received signal property by less than a limit value (G)

The present invention relates to a method for validating a V2X message sent by a transmitter and received by a receiver, wherein the receiver is arranged on a vehicle and at least one actual physical received signal property of the V2X message is determined when the V2X message is received, and wherein from the V2X message a purported transmitter position of the transmitter is determined. Furthermore, the present invention relates to a validation device for validating a V2X message sent by a transmitter and received by a receiver arranged on a vehicle, comprising an extraction unit which is configured to determine from the V2X message a purported transmitter position of the transmitter, wherein an analysis unit is provided, which is designed to determine at least one actual physical received signal property when the V2X message is received.

An exchange of information in road traffic can take place particularly quickly if the communication, i.e. the transmission of messages, is automated. A general communication of a vehicle with another participant is referred to as V2X communication (vehicle-to-X communication) or C2X communication (car-to-X communication). A distinction is also made between the different participants. Communication between a vehicle and further vehicles is referred to as V2V (vehicle-to-vehicle communication) or C2C communication (car-to-car communication), whereas communication between a vehicle and infrastructure and/or external IT systems and/or external IT services is referred to as V2I (vehicle-to-infrastructure communication). In contrast, communication between a vehicle and cloud infrastructure is often referred to as V2C communication (vehicle-to-cloud communication), communication between a vehicle and terminals (e.g., smartphones) of other road users (pedestrians, cyclists, etc.) as V2P communication (vehicle-to-person communication or vehicle-to-pedestrian communication).

For the types of communication mentioned, a WLAN-like IEEE 802.11p standard is on the one hand defined, which enables a message transmission at a frequency in the 5.9 GHz band. On the other hand, C-ITS, a mobile-radio-based approach for 4G (LTE) and 5G networks, is also defined, which enables a message transmission in the frequency 1.8 to 3.5 GHz band. In the standards mentioned, so-called CAMs (common awareness messages) are defined as V2V messages, wherein vehicles transmit among other things their position, direction and speed several times per second, e.g. 10 times per second.

A V2X message can basically comprise information regarding the transmitter (vehicle, infrastructure, etc.) itself and/or regarding other vehicles, e.g. regarding position, speed or the (immediately planned) trajectory of the vehicles in question. This information will have been determined, for example, in advance by the vehicle itself or received via a V2X message from other participants. Furthermore, the message can also comprise information about the infrastructure, for example regarding the position/arrangement of roads, traffic lights, construction sites, etc., whereby the associated status (blocked lanes, current traffic light phases, etc.) can also be included as information. The V2X message is transmitted as a broadcast to all (potential) receivers within the transmission range of the transmitter (usually several tens to several hundred meters). This results in the vehicle receiving only local information, i.e., information within the area of the transmission range and therefore also relevant information.

The V2X message received by a receiver of a vehicle, i.e. the information contained therein, can be used and/or processed by further vehicle systems, for example by driver assistance systems (ADAS) and/or partially automated/fully automated driving systems (AD). For example, the received information can serve to detect objects (e.g., vehicles, obstacles, etc.) in the environment of the vehicle, and thus to support the sensors (video, radar, lidar, etc.) installed in the vehicle. This is particularly advantageous since the V2X message can also contain information relating to objects which cannot be detected by the sensors installed in the vehicle. This can be due to a limited range or to occlusions (non line-of-sight, NLS) of the sensors or even to disturbing environmental conditions (e.g. weather conditions). Information received by means of V2X messages can thus serve, in conjunction with existing sensors, to supplement a situation picture regarding the surroundings of the vehicle. The information contained in the V2X message can also be displayed to the driver, whereby the information can also be processed. For example, information about roadway restrictions in the area of construction sites that is received via V2X message can be displayed to the driver.

The received V2X message can also contain information provided by other participants (e.g. vehicles). As a result of an overall consideration of the information in the V2X messages of a plurality of participants, a dense picture of the local scenario can be generated, whereby, for example, collaborative driving (collective perception messages, CPM) can be supported.

However, there is a risk that information received by means of a V2X message may be unreliable or even incorrect. For example, deliberately incorrect information can be transmitted in order to carry out an attack. For example, an object that is not actually present can be simulated in order to generate a reaction desired by the attacker in the receiving vehicle. Of course, the information can also be incorrect for other reasons, i.e. “by mistake”. In either case, an incorrect assessment of a driving situation can be made on the basis of incorrect information. This may result in inefficient or even dangerous actions being triggered by ADAS/AD systems. For example, there are known cases, in which an emergency braking function of a vehicle was activated by a falsified instruction.

For this reason, it is desirable to evaluate the trustworthiness of the received V2X message in the receiving vehicle to infer the validity of the information transmitted with the V2X message—which is also referred to as “misbehavior detection.”

One known method relates to checking the integrity of the V2X message, for example using checksums or format rules. This method serves primarily to detect transmission errors and is therefore only suitable to a limited extent for validating V2X messages, since V2X messages correctly formulated by an attacker but nevertheless falsified are not detected.

Another method provides that the transmitter authenticates itself, for example by transmitting a signature with a certificate as information in the V2X message. However, this method can be leveraged by an attacker as soon as he gains access to the valid signature of any participant. If a participant is compromised in this manner and compromising is not detected, the signature will remain valid until the compromising is detected and the certificate declared invalid. However, even after the compromising is known, it is technically difficult to declare the certificate of the individual participant invalid and to distribute this information (globally to every participant).

Another method uses a simple plausibility check of the received signal strength of the received V2X message. In this way, a measured RSSI (received signal strength indication) can be compared with an estimated received signal strength. The estimation is based on a transmitter position reported by the transmitter and a distance to the receiver calculated therefrom by using a channel attenuation model. For example, the inverse-square law is provided as a channel-attenuation model, this law stating that the received signal strength is inversely proportional to the square of the distance. However, this results in a plurality of positions of the receiver which pass this plausibility check. For this reason, such a plausibility check can be leveraged by an attacker, by transmitting form a position, which complies with the plausibility check, although it does not correspond to the specified transmitter position. The signal strength can also be adapted to satisfy the plausibility check. DE 2017 124 905 A1 describes a validation of a received message on the basis of a comparison of an estimated received signal strength with an actually occurring received signal strength, wherein the estimated received signal strength is based on an estimated open path signal strength loss.

A particularly computationally intensive method is checking the plausibility of the received information by determining a movement model of the transmitter on the basis of a plurality of positions reported at different points in time. The movement model is compared with plausible assumptions, such as, for example, a maximum speed, a road course, etc., and is thus checked for plausibility. This method requires considerable computing effort in the receiving vehicle, which often means that only a greatly simplified version is possible. A simplification of the criteria will, of course, suit an attacker who only has to generate falsified information with a (somewhat) plausible speed and trajectory.

DE 2009 045 709 A1 discloses a transmission of validation data for the validation of the position data of the transmitter, wherein the validation data are provided by other vehicles. U.S. Pat. No. 10,621,868 B2, on the other hand, takes into account the Doppler effect in validating the validity of the messages. DE 11 2009 001 007 B4 describes a transmission of a message which comprises not only the transmitter position of the transmitting vehicle but also GPS raw data of the transmitting vehicle. The receiver determines the transmitter position of the transmitting vehicle from the received raw GPS data and compares it with the received transmitter position in order to validate the message. Based on this, WO 2018/224101 A1 describes the use of map data for detecting GNSS spoofing by the transmitter. EP 2 593 807 B1 describes a comparison of two relative positionings between transmitter and receiver. The first relative positioning is determined from the respective absolute positions, the second relative positionings by means of two antenna elements. Different power densities occurring are here considered. DE 10 2013 217 869 A1 also takes into account a reception direction, with two antennas being used. EP 2 783 236 B1 describes a position determination of the transmitter, whereas DE 10 2013 207 587 B2 validates the signal by taking the reception angle into account.

It is therefore the object of the present invention to specify an improved method for authenticating V2X messages.

This object is achieved according to the invention by providing local environmental geodata, comprising a position of a number of stationary objects, wherein a signal path of the V2X message is simulated based on the purported transmitter position and taking into account the environmental geodata, wherein at least one simulated physical received signal property is determined from the simulated signal path and the position of the vehicle. The V2X message is validated, if the at least one simulated physical received signal property differs from the at least one actual physical received signal property by less than a limit value.

Furthermore, the object is achieved by a validation device, wherein a geodata unit is provided, which is designed to provide local environmental geodata, comprising a positioning of a number of stationary objects. Furthermore, a simulation unit is provided, which is connected to the extraction unit and to the geodata unit and is designed, by using the asserted transmitter position, the local environmental geodata and a known receiver position of the vehicle to simulate a signal path of the V2X message, and from the simulated signal path and the known receiver position to determine at least one simulated physical received signal property. A validation unit is connected to the simulation unit and to the analysis unit and is designed to validate the V2X message if the at least one simulated physical received signal property differs from the at least one actual physical received signal property by less than a limit value. Of course, the validation device and its subordinate units can be designed to also carry out the further method steps described in the following. A label is considered to be trustworthy as a validation.

A position-determination unit can be provided to determine the receiver position of the vehicle. The position-determination unit can be an integral component of the validation device, or can also be a component of a further device of the vehicle, for example an already installed GNSS system.

According to the invention, it is not merely a potential physical received signal property based on the relative positioning of transmitter and receiver (i.e. distance and orientation) that is calculated and compared with an actual physical received signal property of the received V2X message, but rather a signal path is simulated while taking into account local environmental geodata.

Thus, for the simulated signal path, not only the relative positioning of transmitter and the receiver is decisive, but also local geodata which influence the signal path. Simulating the signal path while taking into account local environmental geodata makes it more difficult for an attacker to falsify a transmitter position, since a falsified transmitter position leads to an incorrect simulated signal path, which results in the simulated physical received signal properties not matching the actual physical received signal properties.

The environmental geodata can be geographical maps (e.g., OpenStreetMap) in which stationary objects such as houses, plants, etc. are recorded. After assignment of the purported transmitter position and the receiver position in relation to the stationary objects in the surroundings of the transmitter and the receiver, the signal path can be simulated starting from the transmitter and taking into account the stationary objects. By taking into account the local geodata during the simulation of the signal path, the physical received signal properties can be “imprinted” by the geodata. Imprinting is understood to mean the detection of objects along the path between the transmitter and the receiver. Since the path changes when the transmitter and/or receiver are moving, during the course of communication correspondingly different stationary objects flow into the communication. The number of objects that were in the path thus increases. The imprinting of a received signal and thus of the physical received signal properties by an object can be expressed, for example, in the form of signal attenuation by the object and/or reflection at the object.

In the simulation of the signal path, a reflection and/or a diffraction and/or an absorption of the V2X message at the stationary objects can be taken into account. Complete absorption and/or partial absorption can be taken into account as absorption. Furthermore, methods such as ray tracing can be used to simulate the signal path.

The simulated signal path and/or the simulated physical received signal property is preferably simulated by means of physical and/or stochastic models and/or with the aid of approximation methods based on machine learning, preferably specially trained neural networks. The computing power required for the simulation can thus be kept low. For example, highly optimized algorithms can also be used, such as the “geometry-based stochastic channel model” (M. Hofer et al., “Evaluation of vehicle-in-the-loop tests for wireless V2X communication,” 2019 IEEE 90th Vehicle Technology Conference (VTC autumn 2019, Honolulu, HI, USA, 2019, pp. 1-5)).

The local environmental geodata preferably comprise physical object properties of the objects. For example, signal-specific physical object properties such as reflection indices and/or signal attenuation of the objects can be contained directly in the local environmental geodata. Signal-specific physical object properties can in particular comprise those physical object properties of the objects which influence channel properties for the frequencies used (e.g. 1.8 to 3.5 or 5 GHz). It is also possible, that physical object properties, for example the object type of the objects (tree, bush, building, mound, etc.), is contained in the local environmental geodata. The signal-specific physical object properties can in turn be derived based on the physical object properties.

An actual reception angle is preferably determined as at least one physical received signal property and a simulated reception angle is determined as at least one simulated physical received signal property. If the local geodata are not taken into account during the simulation of the signal path, a signal receiving angle will not simulated be correctly in the case of a reflection at objects, since the signal path and thus also the signal reception angle are influenced by reflections. In order to determine the actual reception angle, a direction-sensitive antenna (DOA, direction of arrival) can be used, for example an ESPAR antenna (electronically steerable parasitic array radiator).

An actual received signal strength is preferably determined as at least one physical received signal property and a simulated received signal strength is determined as at least one simulated physical received signal property. If the local geodata were not taken into account, it would not be possible to tell whether a low signal strength is present due to a great distance from the vehicle, or due to objects positioned in the surroundings of transmitters and/or receivers.

Furthermore, polarization and/or Doppler shift and/or frequency dispersion and/or signal transit times can be provided as a physical received signal property (and correspondingly as a simulated physical received signal property).

The purported transmitter position can be directly included in the V2X message. The purported transmitter position thus only needs to be read out from the V2X message. However, the purported transmitter position can also be derived from other information contained in the V2X message, whereby the purported transmitter position is implicitly considered to be “purported.” The transmitter position, reported by the transmitter, which can correspond to the actual transmitter position or can differ from the actual transmitter position, is basically considered to be “purported.” Of course, it is also possible to read out the purported transmitter position from the V2X message (since it is contained directly in the V2X message) and, in addition, for example to check the purported transmitter position, to derive it from the V2X message to generate a redundancy. The purported transmitter position can be derived, for example, from a perception of the transmitter transmitted with the V2X message. The purported transmitter position can also be derived from a transmitter ID, in particular if the transmitter is stationary, for example, an infrastructure device (traffic light system, etc.).

Preferably, the V2X message is declared invalid if the at least one simulated physical received signal property differs from the at least one actual physical received signal property by at least the limit value. The V2X message is thus invalidated if it has not been validated.

In the case of the V2X message being declared invalid, the transmitter can be labeled as unreliable. This can be done by labeling a transmitter identification and/or a transmitter certificate of the transmitter as unreliable. Furthermore, a message regarding the unreliability of the transmitter can be sent, which is transmitted, for example, as a broadcast to the vehicles in the surroundings and/or to a central location (e.g., a traffic control center).

The validation is advantageously carried out several times. Since transmitters and/or receivers are in motion and thus travel over an increasing area over time and the transmission path is thus influenced by an increasing number of stationary objects, the above-described “imprinting” of the physical received signal property increases and thus the informative power of the validation.

A purported transmitter speed and/or a purported transmitter acceleration is preferably determined from the V2X message, a calculated transmitter speed and/or a calculated transmitter acceleration is determined from the purported transmitter position of the transmitter, and the V2X message is additionally validated when the purported transmitter speed and/or purported transmitter acceleration differs from the calculated transmitter speed and/or transmitter acceleration preferably by less than a further limit value.

The actual transmitter position of the transmitter can be determined using the local environmental geodata and the actual physical received signal property of the V2X message and compared with the purported transmitter position of the transmitter. The receiver thus estimates the actual transmitter position, e.g., by simulating the actual signal path on the basis of the reception direction and the reception field strength of the V2X message and also the local environmental geodata. As a result, the actual transmitter position can be compared with the purported transmitter position in order to enable an additional validation should the actual transmitter position and the purported transmitter position differ by less than a corresponding position deviation limit value.

Furthermore, an actual transmitter speed of the transmitter can be determined from the actual transmitter position and compared with a purported speed of the transmitter contained in the V2X message. In this way, a further validation can take place if actual (estimated) transmitter speed and purported transmitter speed differ by less than a corresponding speed deviation limit value.

The sensor system of the vehicle is preferably used to verify at least a portion of the information contained in the V2X message, preferably at least the transmitter type of the transmitter. The transmitter type of the transmitter can be differentiated, for example, between cars, trucks, traffic lights, etc. As a transmitter type, the ISO-TS18234-4, TPEG-RTM standard, can be used, for example, in which, for example, “car,” “taxi,” “bus” or tram are defined as “vehicle_type.” For example, in the V2X message the transmitter can transmit a transmitter type as information. For example, a camera (as a sensor system) can be provided at the receiver in order to identify the transmitter type. If the transmitter type identified by the sensor system matches the transmitter type transmitted in the V2X message, this transmitter type will be verified. For example, a speed of the transmitter transmitted in the V2X message can also be transmitted as information, wherein the speed of the transmitter is verified in the receiver with the aid of the sensor system (e.g., front radar with Doppler measurement).

When the information contained in the V2X message has been verified, the V2X message can be validated, i.e. labeled as trustworthy. This validation method can be carried out not only in addition to or even instead of the previously described validation method (simulation of the signal path using the environmental geodata for determining the simulated physical received signal property and comparison of these with an actual physical received signal property).

The V2X message is preferably a V2V message, preferably a common awareness message.

As is known, information contained in a V2X message can be used in the vehicle in order to carry out partially or fully automated driving. If the V2X message has been validated, the information contained will be labeled as trustworthy and can be used for the function of partially or fully automated driving. However, if the V2X message is declared as invalid, the information used in the V2X message will be declared invalid and not used for the function of automated driving (i.e., left out). If further available information (e.g., information determined by existing sensors) is not sufficient for safe performance of the function of automated driving, this function can subsequently be deactivated. Full control over the vehicle can thus be transferred to the driver or a safe stop of the vehicle initiated. It can also occur that the further information present is not sufficient for the complete function of automated driving, but does allow a limited function, for example a reduced speed.

Furthermore, the information contained in the V2X message (e.g., the presence of a construction site) can be displayed in the vehicle and a note regarding the validation of the V2X message, i.e. regarding the trustworthiness of the information, can also be displayed. For example, the driver is informed of the information and, on the other hand, whether this information has been classified as trustworthy.

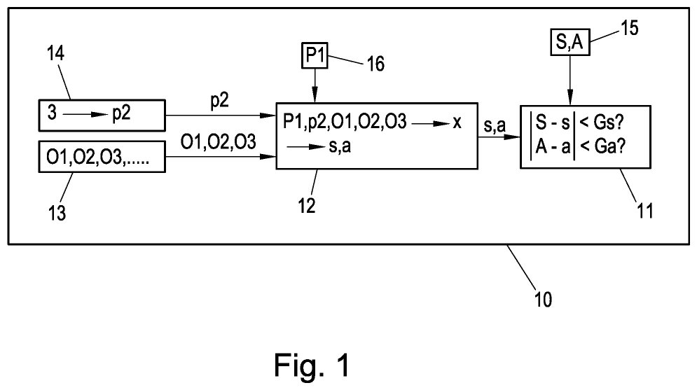

The present invention is described in greater detail below with reference to FIGS. 1 to 4, which show by way of example schematic and non-limiting advantageous embodiments of the invention. The following are shown:

FIG. 1 an exemplary schematic structure of a validation device

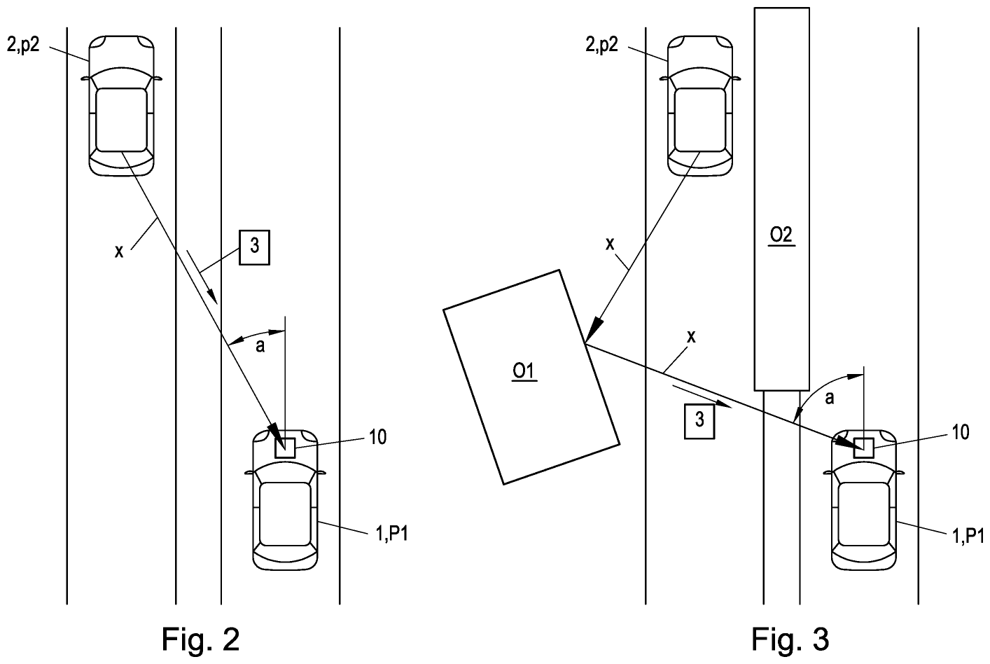

FIG. 2 a direct simulated signal path of a V2X message,

FIG. 3 a simulated signal path of a V2X message reflected at an object,

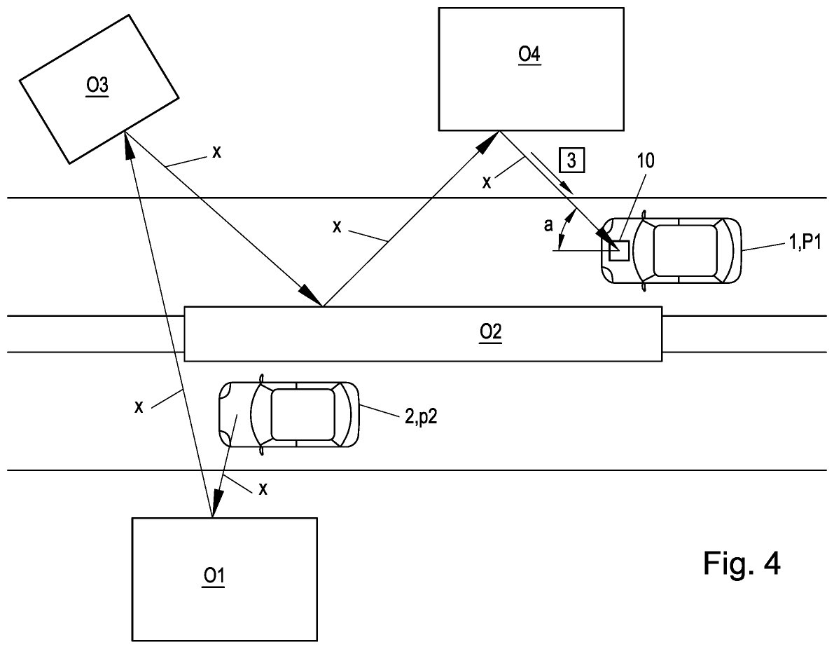

FIG. 4 a simulated signal path of a V2X message reflected at two objects.

A V2X message 3 is transmitted by a transmitter 2 to a receiver 1, a vehicle being provided as the receiver 1. A vehicle (V2V message), but also an infrastructure, an external IT system, an external IT service (V2I message), another road user (V2P message), a cloud service (V2C message), etc. can be provided as the transmitter 2.

On the receiver 1 a validation device 10 as schematically illustrated in FIG. 1 is provided for validating a V2X message 3. The V2X message 3 directly includes a purported transmitter position p2 of the transmitter 2 or contains information from which the purported transmitter position p2 can be derived. For communication with a cloud service (V2C message), the purported position of the active radio mast (for example, a mobile radio transmission mast in the case of C-ITS) can be regarded as purported transmitter position p2.

If the V2X message 3 contains information from which the purported transmitter position p2 can be derived, an extraction unit 14 can be provided, which is designed to determine the purported transmitter position p2 from the V2X message 3. The purported transmitter position p2 can be correct or incorrect (i.e., match the actual transmitter position), wherein an incorrect purported transmitter position p2 can simply be falsified or can even be unintentionally incorrect.

A position-determination unit 16 is provided, which is designed to determine the receiver position P1 of the vehicle 1. The positioning unit 16 can be an integral component of the validation device 10, or can also be a component of another system of the vehicle 1, which provides the receiver position P1 of the validation device 10. It is assumed that the known receiver position P1 of the vehicle is correct.

Furthermore, an analysis unit 15 is provided, which is designed to determine, upon reception of the V2X message 3, at least one actual physical received signal property of the V2X message 3, for example, an actual received signal strength S and/or an actual received signal angle A.

According to the invention, a geodata unit 13 is provided, which is designed to provide local environmental geodata. The environmental geodata comprise positions of stationary objects O1, O2, O3, O4 for example in the form of 2D cards, or 3D cards. As a geodata unit 13, a local memory with positions of the stationary objects O1, O2, O3, O4 and/or a receiving unit for receiving the position of the stationary objects O1, O2, O3, O4 can be provided. An exemplary positioning of stationary objects O1, O2, O3, O4 is shown in FIGS. 2 to 4 and will be described further below.

In addition, according to the invention, a simulation unit 12 is provided, which receives from the extraction unit 14 the purported transmitter position p2 of the transmitter 2. Furthermore, the simulation unit 12 receives the environmental geodata O13 O1, O2, O3, provided by the geodata unit 13. The simulation unit 12 simulates the signal path x of the V2X message 3 from the purported transmitter position p2 to the receiver position P1 taking into account the stationary objects O1, O2, O3, O4. Furthermore, at least one simulated physical received signal property, for example a simulated received signal strength s and/or a simulated received signal angle a, is determined from the simulated signal path x and the receiver position P1. The simulated received signal strength s is dependent on the length of the simulated signal path x and the object types and/or object properties of the objects O1, O2, O3, O4 positioned along the signal path x. For example, trees have a signal-attenuating effect. The simulated received signal angle a results from the orientation of the simulated signal path x impinging on the receiver 1.

In order to verify that the simulated signal path x corresponds to the actual signal path, a validation unit 11 is provided, which receives the at least one simulated physical received signal property from a simulation unit 12 and the at least one actual signal characteristic from the analysis unit 15. The at least one simulated physical received signal property is compared with the at least one actual signal property. If the at least one simulated physical received signal property differs from the at least one actual physical received signal property by less than a limit value G, the V2X message 3 will be validated. It is thus concluded from a correct physical received signal property (i.e. a difference by less than the limit value G from the actual signal property) that the simulated signal path x is correct, whereby it is again inferred that the transmitter position p2 is correct. It can be concluded analogously from an incorrect physical received signal property (i.e. a difference by at least the limit value G from the actual signal property) that the simulated signal path x is incorrect, whereby it is again inferred that the transmitter position p2 is incorrect.

A simulated physical received signal property can be compared with an actual physical received signal property, or a plurality of simulated physical received signal properties can be compared with a plurality of actual physical received signal properties, wherein limit values can be provided in each case. By way of example, FIG. 1 provides, on the one hand, a comparison of the simulated received signal strength s with the actual received signal strength S and, on the other hand, a comparison of the simulated reception angle a with the actual reception angle A. The transmitter 2 preferably emits the V2X message 3 omnidirectionally, i.e. uniformly in the two-dimensional representation in all directions of the plane parallel to a roadway plane. The difference is calculated from the simulated received signal strength s and the actual received signal strength S and the absolute value of the difference is compared with a signal strength limit value Gs: |S−s|<Gs. Furthermore, the difference is calculated from the simulated reception angle a and the actual reception angle A and the absolute value of the difference is compared with an angle limit value Ga: |A—a|<Ga. In the case of a validation of the reception angle A, it is of course taken into account that 0° corresponds to 360°. Thus, for example, at a reception angle A of 359° and a simulated reception angle a of 1°, a difference of 2° and not 358° is determined. Due to the formation of the size of the difference, the same limit value is provided for a positive difference and for a negative difference, and a comparison with an upper limit value can of course also be carried out for a positive difference and a comparison with a lower limit value can be carried out for a negative difference.

In FIGS. 2, 3 and 4, a purported transmitter position p2 of the transmitter 2 and the simulated signal path x are shown in each case. If the transmitter 2 were actually located at the transmitter position p2, the actual signal path would also correspond to the simulated signal path x. The transmitter 2 is represented in the figures only by way of example as a vehicle, as a result of which the V2X message 3 represents a V2V message.

It is assumed In FIG. 2 that no object O1, O2, O3, O4 is located between the transmitter 2 and the receiver 1 as a result of which the V2X message 3 is transmitted along a direct simulated signal path x from the transmitter 2 to the receiver 1. This results in a simulated reception angle a and a simulated received signal strength s (not shown) for the received V2X message 3. The illustration in FIG. 2 is of course only theoretical in nature, since a complete absence of objects O1, O2, O3, O4 is highly unlikely.

FIG. 3 shows the same relative positioning of the transmitter 2 and receiver 1, as in FIG. 2. However, another simulated signal path x occurs here, which is due to the position of the second object O2 between the transmitter 2 and the vehicle 1, which prevents a direct simulated signal path x as shown in FIG. 2. However, a first object O1 is present, at which the V2X message 3 is reflected. The simulated signal path x thus leads from the transmitter 2 to the first object O1, at which the V2X message 3 is reflected, and onward to the receiver 1. This results in a different (in this case more obtuse) reception angle a of the V2X message simulated in FIG. 2 as compared to FIG. 2. Likewise, in FIG. 3 compared to FIG. 2, a different (here more acute) simulated received signal strength s occurs (not shown), which is due to the longer simulated signal path x.

FIG. 4 also shows the same relative arrangement of the transmitter 2 and receiver 1, wherein again a different simulated signal path x occurs, since the V2X message 3 is reflected several times. The simulated signal path x of the V2X message 3 thus leads from the transmitter 2 via a reflection at the first object 1 to a reflection at the third object O3 and via further reflections at the second object O2 and the fourth object O4 to the receiver 1. This results in an entirely different simulated reception angle a of the V2X message 3 in FIG. 4 as compared to FIGS. 2 and 3. In addition, due to the again longer simulated signal path x compared to FIGS. 2 and 3, a further reduced simulated received signal strength S occurs (not shown).

It is thus apparent that the physical received signal properties depend strongly on the local objects O1, O2, O3, O4 in the surroundings of the transmitter 2 and the receiver 1. A signal path x can thus be simulated on the basis of the purported transmitter position p2 and the local geodata and the known receiver position P1, from which in turn physical received signal properties can be simulated. The actual signal properties are determined and compared with the simulated physical received signal properties in order to determine whether the simulated signal path x matches the actual signal path. If this is the case, it can be assumed that the purported transmitter position p2 corresponds to the actual transmitter position, whereby the V2X message 3 can be validated.

In the figures, the signal path x is shown in highly simplified form for better illustration, wherein, in addition to simple shielding effects, only a simple reflection is taken into account while assuming an angle of reflection corresponding to the angle of incidence. In addition to the effects of reflection and shielding, further effects can be taken into account in the simulation of the signal path x, for example also diffraction, etc. In the simulation, a plurality of signal paths x can also be taken into account, wherein effects such as (different) signal transit times, etc. can in turn be taken into account.

The extraction unit 14, analysis unit 15, geodata unit 13, simulation unit 12, validation unit 11 and position-determination unit 16 can be designed as microprocessor-based hardware, for example as a computer or digital signal processor (DSP) on which corresponding software for performing the respective function is executed. The extraction unit 14, analysis unit 15, geodata unit 13, simulation unit 12, validation unit 11 and position-determination unit 16 can also be in each case an integrated circuit, for example, an application-specific integrated circuit (ASIC) or a field-programmable gate array (FPGA), also with a microprocessor. The extraction unit 14, analysis unit 15, geodata unit 13, simulation unit 12, validation unit 11 and position-determination unit 16 can also be implemented as an analog circuit or analog computer. Mixed forms are conceivable as well. Likewise, it is possible for different functions to be implemented as software on the same hardware.

1. A method, comprising:
validating a V2X message sent by a transmitter and received by a receiver, wherein the receiver is arranged on a vehicle;
determining at least one actual physical received signal property of the V2X message, is determined when the V2X message is received;
determining, from the V2X message, a purported transmitter position of the transmitter, wherein local environmental geodata comprising a positioning of a number of stationary objects is provided;
simulating a signal path of the V2X message based on the purported transmitter position and taking into account the environmental geodata and the receiver position, wherein at least one simulated physical received signal property is determined from the simulated signal path and the receiver position; and
validating the V2X message, if the at least one simulated physical received signal property differs from the at least one actual physical received signal property by less than a limit value.

2. The method according to claim 1, wherein the simulation of the signal path and a reflection of the V2X message at the stationary objects is taken into account.

3. The method according to claim 2, wherein the local environmental geodata comprises physical object properties selected from the group consisting of reflection properties and attenuation properties, of the stationary objects.

4. The method according to claim 1, further comprising:
determining an actual reception angle as at least one physical received signal property; and
determining a simulated reception angle as at least one simulated physical received signal property.

5. The method according to claim 1, further comprising:
determining an actual received signal strength as at least one physical received signal property; and
determining a simulated received signal strength as at least one simulated physical received signal property.

6. The method according to claim 1, wherein the purported transmitter position is directly included in the V2X message.

7. The method according to claim 1, wherein the purported transmitter position is derived from information contained in the V2X message.

8. The method according to claim 1, wherein the V2X message is declared invalid, if the at least one simulated physical received signal property differs from the at least one actual physical received signal property by at least the limit value.

9. The method according to claim 8, wherein, the transmitter will be labeled as unreliable, if the V2X message is declared invalid.

10. The method according to claim 1, wherein the validation is carried out several times.

11. The method according to claim 1, further comprising:
determining at least one of a transmitter speed and a transmitter acceleration from the V2X message
determining at least one of a calculated transmitter speed and a calculated transmitter acceleration from the purported transmitter position of the transmitter; and
validating the V2X message, if the at least one of the transmitter speed and transmitter acceleration differ from a respective one of the calculated transmitter speed and the transmitter acceleration.

12. The method according to claim 1, wherein the actual transmitter position of the transmitter is determined using the local environmental geodata and actual physical received signal properties of the V2X message and compared with the purported transmitter position of the transmitter.

13. The method according to claim 12, wherein an actual transmitter speed of the transmitter is determined from the actual transmitter position and compared with a purported speed of the transmitter contained in the V2X message.

14. The method according to claim 1, wherein the sensor system of the vehicle is used to verify at least a portion of the information contained in the V2X message.

15. The method according to claim 1, wherein the V2X message is a V2V message.

16. The method according to claim 1, wherein the simulated signal path is simulated by using a method selected from the group consisting of physical models, stochastic models, and by using approximation methods based on machine learning.

17. A validating device for validating a V2X message sent by a transmitter and received by a receiver, comprising:
an extraction unit, which is configured to determine a purported transmitter position of the transmitter from the V2X message;
an analysis unit, which is configured to determine at least one actual physical received signal property upon reception of the V2X message;
a geodata unit, which is configured to provide local environmental geodata, including a positioning of a number of stationary objects;
a simulation unit, which is connected to the extraction unit and to the geodata unit and is configured to simulate a signal path of the V2X message using the purported transmitter position, the local environmental geodata and the known receiver position of the vehicle, and to determine at least one simulated physical received signal property from the simulated signal path and the known receiver position; and
a validation unit, which is connected to the simulation unit and to the analysis unit and is configured to validate the V2X message, if the at least one simulated physical received signal property differs from the at least one actual physical received signal property by less than a limit value.

18. The validation device according to claim 17, further comprising a position-determination unit, which is configured to determine the receiver position (P1) of the receiver.

19. The method according to claim 1, wherein the simulated physical received signal property is simulated by using a method selected from the group consisting of physical models, stochastic models, and by using approximation methods based on machine learning.
